(19) United States
(12) Patent Application Publication
(10) Pub. No.: US 2018/0343093 A1
(43) Pub. Date: Nov. 29, 2018

(54) SIGNAL TRANSMISSION METHOD AND APPARATUS

(71) Applicant: HUAWEI TECHNOLOGIES CO., LTD., SHENZHEN (CN)

(72) Inventors: Rong LI, Hangzhou (CN); Chaolong ZHANG, Hangzhou (CN); Jian WANG, Hangzhou (CN); Hejia LUO, Hangzhou (CN)

(21) Appl. No.: 16/053,446

(22) Filed: Aug. 2, 2018

Related U.S. Application Data
(63) Continuation of application No. PCT/CN2017/070653, filed on Jan. 9, 2017.

(30) Foreign Application Priority Data
Feb. 4, 2016 (CN) 201610080011.4

(51) Int. Cl. H04L 5/00; H04W 4/70; H04W 72/12

(52) U.S. Cl. CPC H04L 5/0046; H04W 72/1263; H04W 4/70

(57) ABSTRACT

Embodiments of this application provide a signal transmission method, including: obtaining, by a communications device, a bit group from a to-be-sent bitstream, where the bit group includes at least two bits; modulating, by the communications device, the bit group based on a codebook to obtain at least two modulated symbols; mapping, by the communications device, each of the at least two modulated symbols to a corresponding timeslot in a frame; and sending, by the communications device, the mapped at least two modulated symbols, where different modulated symbols obtained by using a same bit group are mapped to different timeslots, and each timeslot includes a plurality of continuous modulated symbol mapping locations used to map modulated symbols obtained by using a plurality of bit groups of the to-be-sent bitstream.

### CROSS-REFERENCE TO RELATED APPLICATIONS

This application is a continuation application of International patent application PCT/CN2017/070653, filed on Jan. 9, 2017, which claims priority to Chinese Patent Application No. 201610080011.4, filed on Feb. 4, 2016, The disclosures of the aforementioned applications are hereby incorporated by reference in their entireties.

### TECHNICAL FIELD

This application relates to the communications field, and more specifically, to a signal transmission method and apparatus.

### BACKGROUND

Compared with a fourth-generation communications system (4G), a fifth-generation communications system (5G) can be applied to more application scenarios, and the scenarios may further include non-human-centric communication scenarios such as Internet of Vehicles and Internet of Things in addition to conventional mobile communication scenarios. Integration of MTC (Machine Type Communication) systems represented by the Internet of Things in 5G foresees existence of massive connections in a next-generation communications system. In such scenarios with massive connections, aside from human-to-human (Human-to-Human, H2H) communication, communication is mainly thing-centric communication, that is, the MTC. Because massive small-packet transmissions easily lead to excessively high power consumption at a transmit end, there is an urgent need to provide a signal transmission method to reduce the transmission power consumption at the transmit end.

### SUMMARY

Embodiments of this application provide a signal transmission method and apparatus, to reduce transmission power consumption at a transmit end. This is particularly applicable to a communication scenario with massive transmissions in a 5G communications system.

According to a first aspect, a signal transmission method is provided, including the following steps: A communications device obtains a bit group from a to-be-sent bitstream. The communications device modulates the bit group based on a codebook to obtain at least two modulated symbols. The communications device maps each of the at least two modulated symbols to a corresponding timeslot in a frame. The communications device sends the mapped at least two modulated symbols. Different modulated symbols obtained by using a same bit group are mapped to different timeslots, and each timeslot includes a plurality of continuous modulated symbol mapping locations used to map modulated symbols obtained by using a plurality of bit groups of the to-be-sent bitstream.

In this embodiment of this application, different modulated symbols obtained by using a same bit group are mapped to different timeslots, and each timeslot includes a plurality of continuous modulated symbol mapping locations used to map modulated symbols obtained by using a plurality of bit groups of the to-be-sent bitstream. In this way, sent symbols are continuous in terms of time, to avoid frequent ON/OFF (on/off) of a radio frequency at a transmit end, thereby avoiding excessively high power consumption at the transmit end. This is particularly applicable to a communication scenario with massive small-packet transmissions.

With reference to the first aspect, in a first possible implementation of the first aspect, the codebook indicates a correspondence between bit groups and modulated symbols and a correspondence between modulated symbols and timeslots.

Optionally, in this embodiment of this application, the communications device may modulate the bit group based on the correspondence that is indicated by the codebook and that is between the bit groups and the modulated symbols, to obtain the at least two modulated symbols. In addition, the communications device may map each of the at least two modulated symbols to the corresponding timeslot in the frame based on the correspondence that is indicated by the codebook and that is between the modulated symbols and the timeslots.

With reference to the first aspect or any possible implementation of the first aspect, in a second possible implementation of the first aspect, the codebook includes a plurality of code words, the code word is a multidimensional complex vector, and the code word includes at least one zero symbol and at least one non-zero symbol.

The codebook mentioned in this embodiment of this application may be referred to as a sparse code multiple access (SCMA, sparse Code Multiple Access) codebook. Certainly, the codebook in this embodiment of this application may have another name.

With reference to the first aspect or any possible implementation of the first aspect, in a third possible implementation of the first aspect, a ranking of each modulated symbol in the plurality of continuous modulated symbol mapping locations is consistent with a ranking of a corresponding bit group in the to-be-sent bitstream. In this way, a receive end can directly obtain original data based on a location of a symbol, thereby implementing simple decoding.

With reference to the first aspect or any possible implementation of the first aspect, in a fourth possible implementation of the first aspect, a quantity of timeslots in the frame is the same as a quantity of timeslots corresponding to a codebook set to which the codebook belongs. The quantity of timeslots corresponding to the codebook set to which the codebook belongs is a sum of quantities of timeslots that may be mapped in all codebooks in the codebook set. For example, a quantity of timeslots corresponding to a 6×4 codebook set is 4, and a quantity of timeslots mapped in each codebook is 2. Optionally, lengths of the timeslots in the frame are equal. Alternatively, the lengths of the timeslots in the frame may not be equal.

In this embodiment of this application, a terminal may determine the codebook in the codebook set. For example, the terminal may randomly select the codebook from the codebook set.

With reference to the first aspect or any possible implementation of the first aspect, in a fifth possible implementation of the first aspect, the communications device may send the mapped at least two modulated symbols by using a single carrier. That is, the mapped at least two modulated symbols are sent by using one carrier.

In this embodiment of this application, the mapped modulated symbols may be sent by using the single carrier. Sending the mapped modulated symbols by using the single carrier enables the receive end to have advantages of a simple structure and wide coverage of a single-carrier system and enables a time domain signal of the transmit end to have an advantage of a low peak to average power ratio (Peak to Average Power Ratio, PAPR).

With reference to the fifth possible implementation of the first aspect, in a sixth possible implementation of the first aspect, the communications device may select a subcarrier from a plurality of subcarriers as the single carrier, to send the mapped at least two modulated symbols. The plurality of subcarriers constitute a continuous spectrum. The plurality of single carriers may have a same carrier width, or there are at least two subcarriers having different carrier widths. A carrier width is a bandwidth of a carrier, that is, a frequency range occupied for modulating the carrier, that is, a difference between a maximum frequency and a minimum frequency of the carrier. For example, if a carrier width of a subcarrier 1 is [10 M, 20 M], and a carrier width of a subcarrier 2 is [30 M, 40 M], it is considered that the subcarrier 1 and the subcarrier 2 have a same carrier width. The communications device may determine, in a codebook set corresponding to the selected subcarrier, a codebook used for data transmission.

Optionally, in this embodiment of this application, codebook sets corresponding to the subcarriers may be the same or different.

Optionally, a single system frame is divided into different quantities of equal-length timeslots based on different specifications of codebook sets used on different subcarriers. In a single system frame, one terminal device may occupy only one subcarrier to send data, and select a codebook from a codebook set corresponding to the subcarrier to process the data.

Optionally, in this embodiment of this application, the plurality of subcarriers may have same or different widths. When the subcarriers have same bandwidths, the terminal device may select the subcarrier based on a transmission rate required by the terminal device and a distance between the terminal device and the receive end. For example, as a distance between a terminal and a base station increases, a narrower carrier width is selected. This is because same energy, when distributed on a narrower spectrum, can be transmitted over a longer distance. As the distance between the terminal and the base station decreases, a transmission distance also decreases. In this case, the terminal may properly select a larger carrier width and distribute the energy on a wider frequency band to communicate with the base station at a higher rate.

Optionally, in this embodiment of this application, the communications device may determine a to-be-used codebook set based on a time domain resource to be used for data transmission. For example, in four timeslots, a 6×4 codebook set is used. In next four timeslots, another 6×4 codebook set is used. The communications device may alternatively determine the to-be-used codebook set based on the subcarrier and a time domain resource that are to be used for data transmission. For example, the selected subcarrier indicates that a specification of the to-be-used codebook set is 6×4, and a specific 6×4 codebook set to be used may be determined based on the time domain resource to be used.

With reference to the first aspect or any possible implementation of the first aspect, the communications device is a terminal device.

According to a second aspect, a signal transmission method is provided, including the following steps: A communications device receives a multiplexed symbol in each timeslot in a frame, where modulated symbols of a plurality of transmit ends are multiplexed into the multiplexed symbol. The communications device obtains, based on a codebook, at least two modulated symbols of each transmit end from multiplexed symbols of at least two timeslots corresponding to the transmit end. The communications device demodulates, based on the codebook, the at least two modulated symbols obtained from the at least two timeslots, to obtain a bit group. The communications device obtains transmit-end data based on the bit group.

With reference to the second aspect, in a first possible implementation of the second aspect, the codebook indicates a correspondence between bit groups and modulated symbols and a correspondence between modulated symbols and timeslots.

Optionally, in this embodiment of this application, the communications device obtains, based on the correspondence that is indicated by the codebook and that is between the modulated symbols and the timeslots, the at least two modulated symbols of each transmit end from the multiplexed symbols of the at least two timeslots corresponding to the transmit end, and demodulates, based on the correspondence that is indicated by the codebook and that is between the bit groups and the modulated symbols, the at least two modulated symbols obtained from the at least two timeslots, to obtain the bit group.

With reference to the second aspect or any possible implementation of the second aspect, in a second possible implementation of the second aspect, a quantity of timeslots in the frame is the same as a quantity of timeslots corresponding to a codebook set to which the codebook belongs. Optionally, lengths of the timeslots in the frame are equal. Alternatively, the lengths of the timeslots in the frame may not be equal.

With reference to the second aspect or any possible implementation of the second aspect, in a third possible implementation of the second aspect, each timeslot includes a plurality of continuous symbol mapping locations, and the obtaining at least two modulated symbols of each transmit end from multiplexed symbols of at least two timeslots corresponding to the transmit end includes: sequentially obtaining modulated symbols in the plurality of continuous symbol mapping locations in each timeslot, where each time modulated symbols obtained in corresponding locations in at least two timeslots are used for co-demodulation to obtain a bit group.

With reference to the second aspect or any possible implementation of the second aspect, in a fourth possible implementation of the second aspect, the codebook includes a plurality of code words, the code word is a multidimensional complex vector, and the code word includes at least one zero symbol and at least one non-zero symbol.

With reference to the second aspect or any possible implementation of the second aspect, the communications device is a base station.

According to a third aspect, a frame is provided, including a plurality of timeslots. Each timeslot includes a plurality of continuous modulated symbol mapping locations used to map modulated symbols corresponding to a plurality of bit groups of a to-be-sent bitstream. Each bit group corresponds to at least two modulated symbols, and the modulated symbols corresponding to each bit group are obtained by modulating the bit group based on a codebook. Different modulated symbols obtained by using a same bit group are mapped to different timeslots.

With reference to the third aspect, in a first possible implementation of the third aspect, a quantity of the timeslots included in the frame is a quantity of timeslots corresponding to a codebook set to which the codebook belongs. Optionally, lengths of the timeslots in the frame are equal. Alternatively, the lengths of the timeslots in the frame may not be equal.

With reference to the third aspect or any possible implementation of the third aspect, in a second possible implementation of the third aspect, the codebook includes a plurality of code words, the code word is a multidimensional complex vector, and the code word includes at least one zero symbol and at least one non-zero symbol.

According to a fourth aspect, a communications device is provided, including a processor, a memory, and a transceiver. The memory is configured to store an instruction, and the processor is configured to invoke the instruction to perform the following processing: obtaining a bit group from a to-be-sent bitstream; modulating, by the communications device, the bit group based on a codebook to obtain at least two modulated symbols; mapping each of the at least two modulated symbols to a corresponding timeslot in a frame; and sending the mapped at least two modulated symbols by using the transceiver. Different modulated symbols obtained by using a same bit group are mapped to different timeslots, and each timeslot includes a plurality of continuous modulated symbol mapping locations used to map modulated symbols obtained by using a plurality of bit groups of the to-be-sent bitstream.

With reference to the fourth aspect, in a first possible implementation of the fourth aspect, the codebook indicates a correspondence between bit groups and modulated symbols and a correspondence between modulated symbols and timeslots.

Optionally, in this embodiment of this application, the processor is configured to invoke the instruction to perform the following processing: modulating the bit group based on the correspondence that is indicated by the codebook and that is between the bit groups and the modulated symbols, to obtain the at least two modulated symbols; and mapping, based on the correspondence that is indicated by the codebook and that is between the modulated symbols and the timeslots, each of the at least two modulated symbols to the corresponding timeslot in the frame.

With reference to the fourth aspect or any possible implementation of the fourth aspect, in a second possible implementation of the fourth aspect, a quantity of timeslots included in the frame is a quantity of timeslots corresponding to a codebook set to which the codebook belongs. Optionally, lengths of the timeslots in the frame are equal. Alternatively, the lengths of the timeslots in the frame may not be equal.

With reference to the fourth aspect or any possible implementation of the fourth aspect, in a third possible implementation of the fourth aspect, the processor is configured to invoke the instruction to specifically perform the following processing:

sending, on a single carrier by using the transceiver, the at least two modulated symbols on which resource mapping has been performed.

With reference to the fourth aspect or any possible implementation of the fourth aspect, in a fourth possible implementation of the fourth aspect, the processor is configured to invoke the instruction to specifically perform the following processing: selecting a subcarrier from a plurality of subcarriers as the single carrier, to send the mapped at least two modulated symbols, where the plurality of subcarriers constitute a continuous spectrum; and determining the codebook based on a codebook set corresponding to the selected subcarrier.

With reference to the fourth aspect or any possible implementation of the fourth aspect, in a fifth possible implementation of the fourth aspect, a ranking of each modulated symbol in the plurality of continuous modulated symbol mapping locations is consistent with a ranking of a corresponding bit group in the to-be-sent bitstream.

With reference to the fourth aspect or any possible implementation of the fourth aspect, in a sixth possible implementation of the fourth aspect, the codebook includes a plurality of code words, the code word is a multidimensional complex vector, and the code word includes at least one zero symbol and at least one non-zero symbol.

With reference to the fourth aspect or any possible implementation of the fourth aspect, in a seventh possible implementation of the fourth aspect, the communications device is a terminal device.

According to a fifth aspect, a communications device is provided, including a processor, a memory, and a transceiver. The memory is configured to store an instruction, and the processor is configured to invoke the instruction to perform the following processing: receiving a multiplexed symbol in each timeslot in a frame by using the transceiver, where modulated symbols of a plurality of transmit ends are multiplexed into the multiplexed symbol; obtaining, based on a codebook, at least two modulated symbols of each transmit end from multiplexed symbols of at least two timeslots corresponding to the transmit end; demodulating, based on the codebook, the at least two modulated symbols obtained from the at least two timeslots, to obtain a bit group; and obtaining transmit-end data based on the bit group.

With reference to the fifth aspect, in a first possible implementation of the fifth aspect, the codebook indicates a correspondence between bit groups and modulated symbols and a correspondence between modulated symbols and timeslots.

Optionally, in this embodiment of this application, the processor is configured to invoke the instruction to perform the following processing: obtaining, based on the correspondence that is indicated by the codebook and that is between the modulated symbols and the timeslots, the at least two modulated symbols of each transmit end from the multiplexed symbols of the at least two timeslots corresponding to the transmit end, and demodulating, based on the correspondence that is indicated by the codebook and that is between the bit groups and the modulated symbols, the at least two modulated symbols obtained from the at least two timeslots, to obtain the bit group.

With reference to the fifth aspect or any possible implementation of the fifth aspect, in a second possible implementation of the fifth aspect, a quantity of timeslots included in the frame is a quantity of timeslots corresponding to a codebook set to which the codebook belongs. Optionally, lengths of the timeslots in the frame are equal. Alternatively, the lengths of the timeslots in the frame may not be equal.

With reference to the fifth aspect or any possible implementation of the fifth aspect, in a third possible implementation of the fifth aspect, each timeslot includes a plurality of continuous symbol mapping locations, and the processor is configured to invoke the instruction to specifically perform the following processing: sequentially obtaining received symbols in the plurality of continuous symbol mapping locations in each timeslot by using the transceiver, where each time received symbols obtained in corresponding locations in at least two timeslots are used for co-demodulation to obtain a bit group.

With reference to the fifth aspect or any possible implementation of the fifth aspect, in a fourth possible implementation of the fifth aspect, the codebook includes a plurality of code words, the code word is a multidimensional complex vector, and the code word includes at least one zero symbol and at least one non-zero symbol.

With reference to the fifth aspect or any possible implementation of the fifth aspect, in a fifth possible implementation of the fifth aspect, the communications device is a base station.

According to a sixth aspect, a communications device is provided, including an obtaining unit, a modulation unit, a mapping unit, and a sending unit. The obtaining unit is configured to obtain a bit group from a to-be-sent bitstream. The modulation unit is configured to modulate, by the communications device, the bit group based on a codebook to obtain at least two modulated symbols. The mapping unit is configured to map each of the at least two modulated symbols to a corresponding timeslot in a frame. The sending unit is configured to send the mapped at least two modulated symbols. Different modulated symbols obtained by using a same bit group are mapped to different timeslots, and each timeslot includes a plurality of continuous modulated symbol mapping locations used to map modulated symbols obtained by using a plurality of bit groups of the to-be-sent bitstream.

With reference to the sixth aspect, in a first possible implementation of the sixth aspect, the codebook indicates a correspondence between bit groups and modulated symbols and a correspondence between modulated symbols and timeslots.

Optionally, in this embodiment of this application, the communications device may modulate the bit group based on the correspondence that is indicated by the codebook and that is between the bit groups and the modulated symbols, to obtain the at least two modulated symbols; and map, based on the correspondence that is indicated by the codebook and that is between the modulated symbols and the timeslots, each of the at least two modulated symbols to the corresponding timeslot in the frame.

With reference to the sixth aspect or any possible implementation of the sixth aspect, in a second possible implementation of the sixth aspect, a quantity of timeslots in the frame is the same as a quantity of timeslots corresponding to a codebook set to which the codebook belongs. Optionally, lengths of the timeslots in the frame are equal. Alternatively, the lengths of the timeslots in the frame may not be equal.

With reference to the sixth aspect or any possible implementation of the sixth aspect, in a third possible implementation of the sixth aspect, the communications device sends, by using a single carrier, the at least two modulated symbols on which resource mapping has been performed.

With reference to the sixth aspect or any possible implementation of the sixth aspect, in a fourth possible implementation of the sixth aspect, before the sending, by using a single carrier, the at least two modulated symbols on which resource mapping has been performed, the communications device selects a subcarrier from a plurality of subcarriers as the single carrier, to send the mapped at least two modulated symbols, where the plurality of subcarriers constitute a continuous spectrum; and determines the codebook in a codebook set corresponding to the selected subcarrier.

With reference to the sixth aspect or any possible implementation of the sixth aspect, in a fifth possible implementation of the sixth aspect, a ranking of each modulated symbol in the plurality of continuous modulated symbol mapping locations is consistent with a ranking of a corresponding bit group in the to-be-sent bitstream.

With reference to the sixth aspect or any possible implementation of the sixth aspect, in a sixth possible implementation of the sixth aspect, the codebook includes a plurality of code words, the code word is a multidimensional complex vector, and the code word includes at least one zero symbol and at least one non-zero symbol.

With reference to the sixth aspect or any possible implementation of the sixth aspect, in a sixth possible implementation of the sixth aspect, the communications device is a terminal device.

According to a seventh aspect, a communications device is provided, including a receiving unit and an obtaining unit. The receiving unit is configured to receive a multiplexed symbol in each timeslot in a frame, where modulated symbols of a plurality of transmit ends are multiplexed into the multiplexed symbol. The obtaining unit is configured to: obtain, based on a codebook, at least two modulated symbols of each transmit end from multiplexed symbols of at least two timeslots corresponding to the transmit end; demodulate, based on the codebook, the at least two modulated symbols obtained from the at least two timeslots, to obtain a bit group; and obtain transmit-end data based on the bit group.

With reference to the seventh aspect, in a first possible implementation of the seventh aspect, the codebook indicates a correspondence between bit groups and modulated symbols and a correspondence between modulated symbols and timeslots.

Optionally, in this embodiment of this application, the obtaining unit may obtain, based on the correspondence that is indicated by the codebook and that is between the modulated symbols and the timeslots, the at least two modulated symbols of each transmit end from the multiplexed symbols of the at least two timeslots corresponding to the transmit end, and demodulate, based on the correspondence that is indicated by the codebook and that is between the bit groups and the modulated symbols, the at least two modulated symbols obtained from the at least two timeslots, to obtain the bit group.

With reference to the seventh aspect or any possible implementation of the seventh aspect, in a second possible implementation of the seventh aspect, a quantity of timeslots in the frame is the same as a quantity of timeslots corresponding to a codebook set to which the codebook belongs. Optionally, lengths of the timeslots in the frame are equal. Alternatively, the lengths of the timeslots in the frame may not be equal.

With reference to the seventh aspect or any possible implementation of the seventh aspect, in a third possible implementation of the seventh aspect, each timeslot includes a plurality of continuous symbol mapping locations, and the obtaining at least two modulated symbols of each transmit end from multiplexed symbols of at least two timeslots corresponding to the transmit end includes: sequentially obtaining received symbols in the plurality of continuous symbol mapping locations in each timeslot, where each time received symbols obtained in corresponding locations in at least two timeslots are used for co-demodulation to obtain a bit group.

With reference to the seventh aspect or any possible implementation of the seventh aspect, in a fourth possible implementation of the seventh aspect, the codebook includes a plurality of code words, the code word is a multidimensional complex vector, and the code word includes at least one zero symbol and at least one non-zero symbol.

With reference to the seventh aspect or any possible implementation of the seventh aspect, in a fifth possible implementation of the seventh aspect, the communications device is a base station.

According to an eighth aspect, a memory is provided. The memory is configured to store a computer-readable instruction, where the instruction is used to perform the following operations: obtaining a bit group from a to-be-sent bitstream; modulating the bit group based on a codebook to obtain at least two modulated symbols; mapping each of the at least two modulated symbols to a corresponding timeslot in a frame; and sending the mapped at least two modulated symbols. Different modulated symbols obtained by using a same bit group are mapped to different timeslots, and each timeslot includes a plurality of continuous modulated symbol mapping locations used to map modulated symbols obtained by using a plurality of bit groups of the to-be-sent bitstream.

With reference to the eighth aspect, in a first possible implementation of the eighth aspect, the codebook indicates a correspondence between bit groups and modulated symbols and a correspondence between modulated symbols and timeslots.

Optionally, in this embodiment of this application, the instruction may be used to perform the following operations: modulating the bit group based on the correspondence that is indicated by the codebook and that is between the bit groups and the modulated symbols, to obtain the at least two modulated symbols; and mapping, based on the correspondence that is indicated by the codebook and that is between the modulated symbols and the timeslots, each of the at least two modulated symbols to the corresponding timeslot in the frame.

With reference to the eighth aspect or any possible implementation of the eighth aspect, in a second possible implementation of the eighth aspect, a quantity of timeslots in the frame is the same as a quantity of timeslots corresponding to a codebook set to which the codebook belongs. Optionally, lengths of the timeslots in the frame are equal. Alternatively, the lengths of the timeslots in the frame may not be equal.

With reference to the eighth aspect or any possible implementation of the eighth aspect, in a third possible implementation of the eighth aspect, the instruction is specifically used to:

send, by using a single carrier, the at least two modulated symbols on which resource mapping has been performed.

With reference to the eighth aspect or any possible implementation of the eighth aspect, in a fourth possible implementation of the eighth aspect, the instruction is specifically used to: before the sending, by using a single carrier, the at least two modulated symbols on which resource mapping has been performed, select a subcarrier from a plurality of subcarriers as the single carrier, to send the mapped at least two modulated symbols, where the plurality of subcarriers constitute a continuous spectrum; and determine the codebook in a codebook set corresponding to the selected subcarrier.

With reference to the eighth aspect or any possible implementation of the eighth aspect, in a fifth possible implementation of the eighth aspect, a ranking of each modulated symbol in the plurality of continuous modulated symbol mapping locations is consistent with a ranking of a corresponding bit group in the to-be-sent bitstream.

With reference to the eighth aspect or any possible implementation of the eighth aspect, in a sixth possible implementation of the eighth aspect, the codebook includes a plurality of code words, the code word is a multidimensional complex vector, and the code word includes at least one zero symbol and at least one non-zero symbol.

According to a ninth aspect, a memory is provided. The memory is configured to store a computer-readable instruction, where the instruction is used to perform the following operations: receiving a multiplexed symbol in each timeslot in a frame, where modulated symbols of a plurality of transmit ends are multiplexed into the multiplexed symbol; obtaining, based on a codebook, at least two modulated symbols of each transmit end from multiplexed symbols of at least two timeslots corresponding to the transmit end; demodulating, based on the codebook, the at least two modulated symbols obtained from the at least two timeslots, to obtain a bit group; and obtaining transmit-end data based on the bit group.

With reference to the ninth aspect, in a first possible implementation of the ninth aspect, the codebook indicates a correspondence between bit groups and modulated symbols and a correspondence between modulated symbols and timeslots.

The instruction may be used to perform the following operations: obtaining, based on the correspondence that is indicated by the codebook and that is between the modulated symbols and the timeslots, the at least two modulated symbols of each transmit end from the multiplexed symbols of the at least two timeslots corresponding to the transmit end, and demodulating, based on the correspondence that is indicated by the codebook and that is between a modulated symbol and a bit group, the at least two modulated symbols obtained from the at least two timeslots, to obtain the bit group.

With reference to the ninth aspect or any possible implementation of the ninth aspect, in a second possible implementation of the ninth aspect, a quantity of timeslots in the frame is the same as a quantity of timeslots corresponding to a codebook set to which the codebook belongs. Optionally, lengths of the timeslots in the frame are equal. Alternatively, the lengths of the timeslots in the frame may not be equal.

With reference to the ninth aspect or any possible implementation of the ninth aspect, in a third possible implementation of the ninth aspect, each timeslot includes a plurality of continuous symbol mapping locations, and the instruction is specifically used to:

sequentially obtaining received symbols in the plurality of continuous symbol mapping locations in each timeslot, where each time received symbols obtained in corresponding locations in at least two timeslots are used for co-demodulation to obtain a bit group.

With reference to the ninth aspect or any possible implementation of the ninth aspect, in a third possible implementation of the ninth aspect, the codebook includes a plurality of code words, the code word is a multidimensional complex vector, and the code word includes at least one zero symbol and at least one non-zero symbol.

### BRIEF DESCRIPTION OF DRAWINGS

To describe the technical solutions in the embodiments of this application more clearly, the following briefly introduces the accompanying drawings required for describing the embodiments. Apparently, the accompanying drawings in the following description show merely some embodiments of this application, and a person of ordinary skill in the art may still derive other drawings from these accompanying drawings without creative efforts.

FIG. 1 is a diagram of an applicable communication scenario according to an embodiment of this application;

FIG. 2 is a schematic flowchart of a signal transmission method according to an embodiment of this application;

FIG. 3 is a schematic flowchart of signal processing according to an embodiment of this application;

FIG. 4 is a schematic diagram of resource mapping of each codebook according to an embodiment of this application;

FIG. 5 is a schematic diagram of symbol mapping performed according to a correspondence that is indicated by a codebook and that is between the modulated symbols and the timeslots according to an embodiment of this application;

FIG. 6 is a schematic flowchart of signal processing according to an embodiment of this application;

FIG. 7 is a schematic diagram of division of a time-frequency resource according to an embodiment of this application;

FIG. 8 is a schematic diagram of division of a time-frequency resource according to an embodiment of this application;

FIG. 9 is a schematic flowchart of a signal transmission method according to an embodiment of this application;

FIG. 10 is a schematic flowchart of a signal transmission method according to an embodiment of this application;

FIG. 11 is a schematic block diagram of a signal transmission apparatus according to an embodiment of this application;

FIG. 12 is a schematic block diagram of a signal transmission apparatus according to an embodiment of this application;

FIG. 13 is a schematic block diagram of a signal transmission apparatus according to an embodiment of this application; and

FIG. 14 is a schematic block diagram of a signal transmission apparatus according to an embodiment of this application.

### DESCRIPTION OF EMBODIMENTS

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application without creative efforts shall fall within the protection scope of this application.

Terms such as “component”, “module”, and “system” used in this specification are used to indicate computer-related entities, hardware, firmware, combinations of hardware and software, software, or software being executed. For example, a component may be, but is not limited to, a process that runs on a processor, a processor, an object, an executable file, a thread of execution, a program, and/or a computer. As shown in figures, both a computing device and an application that runs on a computing device may be components. One or more components may reside within a process and/or a thread of execution, and a component may be located on one computer and/or distributed between two or more computers. In addition, these components may be executed from various computer-readable media that store various data structures. For example, the components may communicate by using a local and/or remote process and based on, for example, a signal having one or more data packets (for example, data from one components interacting with another component in a local system, a distributed system, and/or across a network such as the Internet interacting with other systems by using the signal). The one or more data packets may be, for example, data from two components interacting with another component in a local system, a distributed system, and/or across a network such as the Internet interacting with other systems by using a signal.

The embodiments are described with reference to a terminal device and a network device in this application. The terminal device may also be referred to as an access terminal, a subscriber unit, a subscriber station, a mobile station, a mobile, a remote station, a remote terminal, a mobile device, a user terminal, a terminal, a wireless communications device, a user agent, or a user apparatus. The access terminal may be a cellular phone, a cordless phone, a SIP (Session Initiation Protocol, Session Initiation Protocol) phone, a WLL (Wireless Local Loop, wireless local loop) station, a PDA (Personal Digital Assistant, personal digital assistant), a handheld device having a wireless communication function, a computing device, another processing device connected to a wireless modem, an in-vehicle device, a wearable device, or a terminal device in a future 5G network. The network device may be configured to communicate with a mobile device. The network device may be a BTS (Base Transceiver Station, base transceiver station) in GSM (Global System for Mobile communications, Global System for Mobile Communications) or CDMA (Code Division Multiple Access, Code Division Multiple Access), or may be an NB (NodeB, NodeB) in WCDMA (Wideband Code Division Multiple Access, Wideband Code Division Multiple Access), or may be an eNB or an eNodeB (EvolvedNode B, evolved NodeB) in LTE (Long Term Evolution, Long Term Evolution), a relay station, an access point, an in-vehicle device, a wearable device, or a network device in a future 5G network.

In addition, aspects or features of this application may be implemented as a method, an apparatus, or a product that uses standard programming and/or engineering technologies. The term “product” used in this application covers a computer program that can be accessed from any computer-readable component, carrier, or medium. For example, the computer-readable medium may include, but is not limited to, a magnetic storage component, an optical disc, a smart card, and a flash memory component. The magnetic storage component may be, for example, a hard disk, a floppy disk, or a magnetic tape. The optical disc may be, for example, a CD (Compact Disc, compact disc) or a DVD (Digital Versatile Disc, digital versatile disc). The smart card and the flash memory component may be, for example, an EPROM (Erasable Programmable Read-Only Memory, erasable programmable read-only memory), a card, a stick, or a key drive. In addition, various storage media described in this specification may indicate one or more devices and/or other machine-readable media configured to store information. The term “machine-readable medium” may include, but is not limited to, a radio channel and various other media that can store, contain, and/or carry an instruction and/or data.

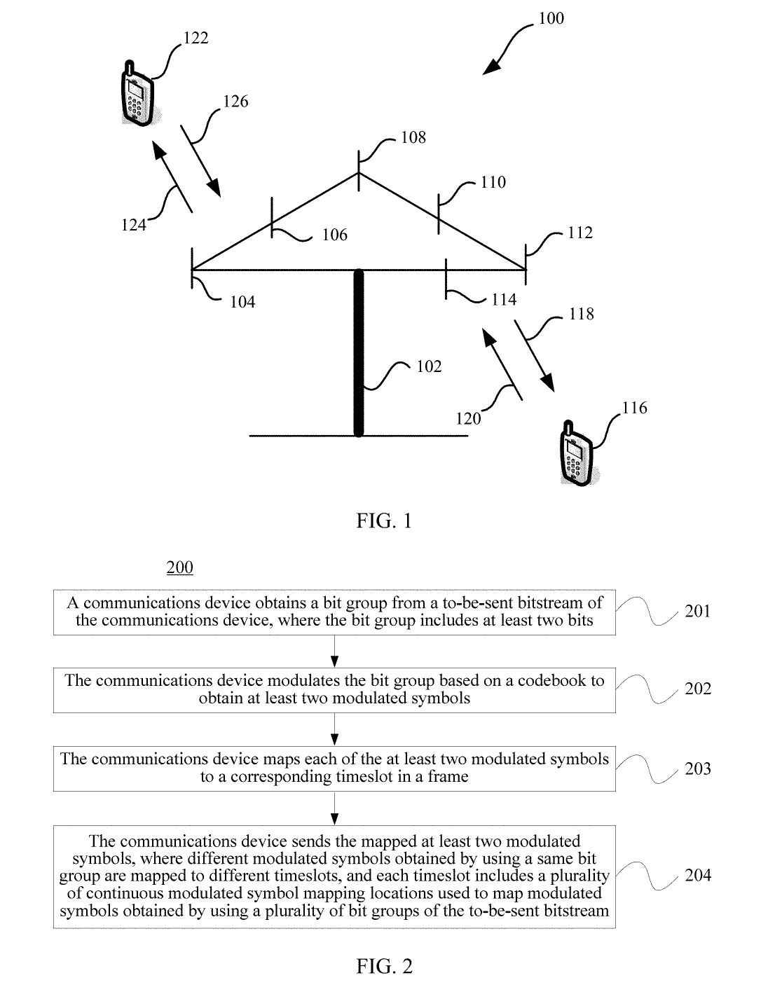

FIG. 1 is a schematic diagram of a communications system used in an embodiment of this application. As shown in FIG. 1, the communications system 100 includes a network device 102, and the network device 102 may include a plurality of antenna groups. Each antenna group may include one or more antennas. For example, one antenna group may include antennas 104 and 106, another antenna group may include antennas 108 and 110, and an additional group may include antennas 112 and 114. For each antenna group, two antennas are shown in FIG. 1; however, more or fewer antennas may be used for each group. The network device 102 may additionally include a transmitter chain and a receiver chain. A person of ordinary skill in the art may understand that the transmitter chain and the receiver chain may both include a plurality of components related to signal sending and receiving, for example, a processor, a modulator, a multiplexer, a demodulator, a demultiplexer, or an antenna.

The network device 102 may communicate with a plurality of terminal devices. For example, the network device 102 may communicate with a terminal device 116 and a terminal device 122. However, it may be understood that the network device 102 may communicate with any quantity of terminal devices similar to the terminal device 116 or 122. The terminal devices 116 and 122 may each be, for example, a cellular phone, a smartphone, a portable computer, a handheld communications device, a handheld computing device, a satellite radio apparatus, a global positioning system, a PDA, and/or any other suitable device configured to perform communication in the wireless communications system 100.

As shown in FIG. 1, the terminal device 116 communicates with the antennas 112 and 114. The antennas 112 and 114 send information to the terminal device 116 by using a forward link 118, and receive information from the terminal device 116 by using a reverse link 120. In addition, the terminal device 122 communicates with the antennas 104 and 106. The antennas 104 and 106 send information to the terminal device 122 by using a forward link 124, and receive information from the terminal device 122 by using a reverse link 126.

For example, in a frequency division duplex (FDD, Frequency Division Duplex) system, the forward link 118 may use a frequency band different from a frequency band used by the reverse link 120; the forward link 124 may use a frequency band different from a frequency band used by the reverse link 126.

For another example, in a time division duplex (TDD, Time Division Duplex) system and a full duplex (Full Duplex) system, the forward link 118 and the reverse link 120 may use a same frequency band, and the forward link 124 and the reverse link 126 may use a same frequency band.

Each group of antennas and/or an area designed for communication is referred to as a sector of the network device 102. For example, an antenna group may be designed to communicate with a terminal deice in a sector within a coverage area of the network device 102. In a process in which the network device 102 respectively communicates with the terminal devices 116 and 122 by using the forward links 118 and 124, a transmit antenna of the network device 102 may improve signal-to-noise ratios of the forward links 118 and 124 through beamforming. In addition, compared with a manner in which the network device sends a signal to all terminal devices served by the network device by using a single antenna, when the network device 102 sends, through beamforming, a signal to the terminal devices 116 and 122 that are randomly distributed in a related coverage area, less interference is caused to a mobile device in a neighboring cell.

In a given time, the network device 102, the terminal device 116, or the terminal device 122 may be a wireless communications sending apparatus and/or a wireless communications receiving apparatus. When sending data, the wireless communications sending apparatus may encode the data for transmission. Specifically, the wireless communications sending apparatus may obtain a particular quantity of data bits to be sent to a wireless communications receiving apparatus by using a channel. For example, the wireless communications sending apparatus may generate, receive from another communications apparatus, or store in a memory, the particular quantity of data bits to be sent to the wireless communications receiving apparatus by using the channel. Such data bits may be included in a transport block or a plurality of transport blocks of data, and the transport block may be segmented to generate a plurality of code blocks.

In this embodiment of this application, a plurality of terminal devices may multiplex a same time-frequency resource to perform transmission to the network device. Therefore, the network device may transmit data to a plurality of terminal devices at a same time point. Processes of transmitting data to the terminal devices by the network device are similar. Therefore, for ease of understanding and description, a procedure in which the network device transmits data to one of the plurality of terminal devices is described below as an example.

FIG. 2 is a schematic flowchart of a signal transmission method 200 according to an embodiment of this application. The method may be applied to a 5G communications system, and specifically, may be applied to an M2M communication service that includes, but is not limited to, intelligent meter reading, smart grid, security monitoring, forest protection, intelligent transportation, electronic medical treatment, and the like in a large-scale MTC communication scenario in the 5G communications system. The method 200 may be performed by a communications device, and the communications device may be a terminal device or a base station. However, this embodiment of this application is mainly described by using an example in which the terminal device performs the method 200.

In 201, the communications device obtains a bit group from a to-be-sent bitstream of the communications device. Optionally, the bit group includes at least two bits.

In 202, the communications device modulates the bit group based on a codebook to obtain at least two modulated symbols.

In 203, the communications device maps each of the at least two modulated symbols to a corresponding timeslot in a frame.

In 204, the communications device sends the mapped at least two modulated symbols.

Different modulated symbols obtained by using a same bit group are mapped to different timeslots, and each timeslot includes a plurality of continuous modulated symbol mapping locations used to map modulated symbols obtained by using a plurality of bit groups of the to-be-sent bitstream.

Specifically, in 201, the communications device may obtain a plurality of bit groups from the to-be-sent bitstream to perform modulation processing. Each bit group may include at least two bits, and a specific quantity of bits in the bit group is related to a codebook used for subsequent modulation.

The concept of the bit group mentioned in this embodiment of this application is merely for ease of description, and represents a smallest unit for modulation processing. There may be no grouping action during modulation processing, and bits needed for modulation processing each time are referred to as a bit group. Each bit group may include at least one bit, and each bit group may be modulated as a whole to obtain at least two modulated symbols.

Before the bit group is obtained from the to-be-sent bitstream for modulation, the following processing may further be performed: adding a cyclic redundancy check (Cyclic Redundancy Check, CRC) code to a transport block (Transport Block, TB), segmenting the transport block to obtain a plurality of sub-blocks, adding a CRC code to each sub-block, and performing channel encoding, rate matching, and code block cascading on each sub-block.

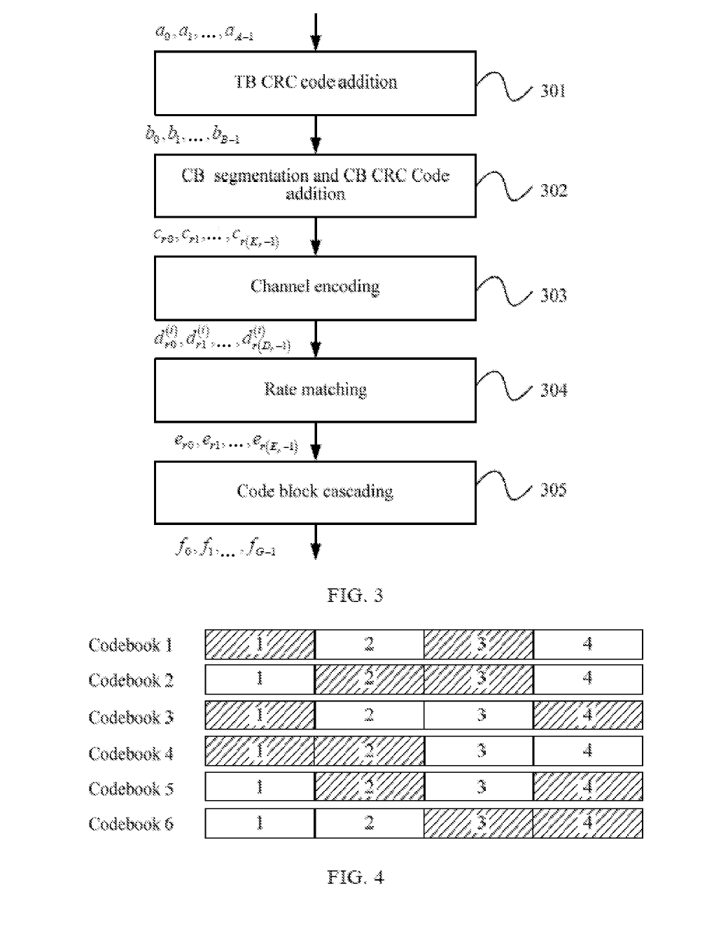

Specifically, as shown in FIG. 3, it is assumed that a to-be-sent information bit sequence of user equipment is a₀,a₁,K,a_{A-1}, and has a length of A. In 301, a CRC code is added to the to-be-sent information bit to obtain a sequence b₀, b₁,K,b_{B-1}. In 302, if A>B, the to-be-sent information bit to which the CRC code has been added is segmented into K blocks based on a length of B, and a CRC code is further added to each sub-block, to obtain a sequence cᵣ₀,cᵣ₁,K,c_{r(K}_{ᵣ}₋₁₎. In 303, next, each sub-block is sent into a channel encoder such as a Turbo encoder for channel encoding, and an output of the encoding is dᵣ₀⁽ⁱ⁾,dᵣ₁⁽ⁱ⁾,K,d_{r(D}_{ᵣ}₋₁₎⁽ⁱ⁾. In 304, rate matching is performed based on a given bit rate, and an output is eᵣ₀,eᵣ₁,K,e_{r(F}⁻¹⁾. In 305, code block cascading is performed on a result of the rate matching to obtain a sequence f₀, f₁,K,f_{G-1}, that is, the to-be-sent bitstream mentioned in 201.

In this embodiment of this application, the terminal device may determine a codebook used to perform modulation processing on data. The terminal device may determine the codebook in a codebook set, or may determine a pre-specified codebook in configuration information.

The codebook mentioned in this embodiment of this application is a codebook in a codebook set. The codebook set may have a plurality of specifications, for example, a 6×4 codebook set, a 12×8 codebook set, or a 24×8 codebook set. If a 6×4 codebook set is selected, it means that there are 6 codebooks in a current system frame for a transmit end to select for data modulation, and 4 equal-length data transmission timeslots exist. If a 12×8 codebook set is selected, it means that there are 12 codebooks in a current system frame for a transmit end to select for data modulation, and 8 equal-length data transmission timeslots exist. A length of a single timeslot (slot) is greatly greater than a length of duration of a single modulated symbol of data. Therefore, a single timeslot may have a plurality of continuous modulated symbol mapping locations. The codebook used by the terminal device to perform modulation processing may be a codebook selected by the terminal device from the codebook set, or may be a codebook pre-configured in the terminal device.

The codebook mentioned in this embodiment of this application includes a plurality of code words. The code word is a multidimensional complex vector, and the code word includes at least one zero symbol and at least one non-zero symbol.

The codebook mentioned in this embodiment of this application may be referred to as a sparse code multiple access (SCMA, sparse Code Multiple Access) codebook. Certainly, the codebook in this embodiment of this application may have another name.

Specifically, SCMA is a new multiple access manner. According to the access manner, a plurality of users multiplex a same time-frequency resource block to perform data transmission. Using an SCMA system based on a single carrier as an example, it is assumed that a length of an SCMA codebook is L, that is, L modulated symbols are needed to map a group of S-bits long data blocks. One subframe is divided into L timeslots, and each timeslot can accommodate M modulated symbols. Therefore, M*L modulated symbols may be mapped to one subframe. When a terminal device #k sends data, the terminal device #k first divides to-be-sent data into S-bits long data blocks, searches for a codebook of a user #k, and then maps the S-bits long data blocks into corresponding modulated symbols X#k={X#k1, X#k2, . . . , X#KL}. Then, modulated symbols into which a first group of S-bits long data blocks are mapped are sequentially mapped to a first location in the L timeslots, modulated symbols into which a second group of S-bits long data blocks are mapped are sequentially mapped to a second location in the L timeslots, and so on, until modulated symbols into which an M^{th} group of S-bits long data blocks are mapped are sequentially mapped to an M^{th} location in the L timeslots. When the symbols are transmitted, a symbol in a first timeslot is a first symbol in the modulated symbols into which all the S-bits long data blocks are mapped, and a symbol in a second timeslot is a second symbol in the modulated symbols into which all the S-bits long data blocks are mapped. By analogy, a symbol in an L^{th} timeslot is an L^{th} symbol in the modulated symbols into which all the S-bits long data block is mapped.

In this embodiment of this application, different modulated symbols obtained by modulating a same bit group are mapped to different timeslots, and each timeslot includes a plurality of continuous modulated symbol mapping locations used to map modulated symbols obtained by using a plurality of bit groups of the to-be-sent bitstream. In this way, sent symbols are continuous in terms of time, to prevent the transmit end from mapping different modulated symbols obtained by modulating a same bit group to a same timeslot, and avoid frequent ON/OFF (on/off) of a radio frequency due to that mapping of modulated symbols obtained by using one bit group is performed after mapping of modulated symbols obtained by using another bit group is completed in a time domain, thereby avoiding excessively high power consumption at the transmit end. This is particularly applicable to a communication scenario with massive small-packet transmissions.

Optionally, in this embodiment of this application, a ranking of each modulated symbol in the plurality of continuous modulated symbol mapping locations is consistent with a ranking of a corresponding bit group in the to-be-sent bitstream. For example, if a location of a bit group in the bitstream is an n^{th} location based on a sequential order, a location occupied by the modulated symbols generated by using the bit group is also an n^{th} location in modulated symbols in a corresponding timeslot. In this way, a receive end can directly obtain original data based on a location of a symbol, thereby implementing simple decoding.

Optionally, in this embodiment of this application, a quantity of timeslots in the frame is the same as a quantity of timeslots corresponding to the codebook set to which the codebook belongs; the quantity of timeslots in the frame is greater than a quantity of timeslots to which the at least two modulated symbols obtained through modulation are mapped; and a ratio of the quantity of timeslots in the frame to a terminal quantity is less than the quantity of timeslots to which the at least two modulated symbols obtained through modulation are mapped. The terminal quantity is a quantity of terminals using codebooks in a same codebook set.

The quantity of timeslots corresponding to the codebook set to which the codebook belongs is a sum of quantities of timeslots that may be mapped in all codebooks in the codebook set, and the quantity of timeslots to which the at least two modulated symbols obtained through modulation are mapped is a quantity of timeslots mapped in each codebook. For example, a quantity of timeslots corresponding to a 6×4 codebook set is 4, and a quantity of timeslots mapped in each codebook is 2.

Optionally, in this embodiment of this application, lengths of the timeslots in the frame are equal. Certainly, the lengths of the timeslots in the frame may not be equal.

The codebook in this application indicates a correspondence between bit groups and modulated symbols and a correspondence between modulated symbols and timeslots. In the following description, sometimes, for ease of description rather than limitation, the correspondence between the bit groups and the modulated symbols is referred to as a bit-symbol mapping relationship, and the correspondence between the modulated symbols and the timeslots is referred to as a symbol-timeslot mapping relationship.

Optionally, in this embodiment of this application, the communications device may modulate the bit group based on the bit-symbol mapping relationship indicated by the codebook, to obtain the at least two modulated symbols; and map, based on the symbol-timeslot mapping relationship, each of the at least two modulated symbols to the corresponding timeslot in the frame.

The following describes the bit-symbol mapping relationship and the symbol-timeslot mapping relationship by using a codebook set having a specification of 6×4 as an example.

In a 6×4 codebook set, there are 6 different codebooks in total. When a codebook in the codebook set is used for modulation, two modulated symbols (S1(xx), S2(xx)) are generated after each two original bits are mapped by using the codebook. Because the two original bits have four possible combinations (00, 01, 10, 11) in total, four possible combinations of modulated symbols may be generated. The bit-symbol mapping relationship may be shown in the following Table 1:

TABLE 1

| Bit | Symbol 1 | Symbol 2 |
|---|---|---|
| 00 | S1(00) | S2(00) |
| 01 | S1(01) | S2(01) |
| 10 | S1(10) | S2(10) |
| 11 | S1(11) | S2(11) |

The codebook in this application may further indicate the symbol-timeslot mapping relationship used to indicate a timeslot to which a symbol obtained through mapping should correspond.

Timeslot indexes corresponding to the 6 codebooks in the codebook set having a specification of 6×4 may be shown in Table 2:

TABLE 2

| Codebook index | Slot index {a, b} |
|---|---|
| 1 | {1, 3} |
| 2 | {2, 3} |
| 3 | {1, 4} |
| 4 | {1, 2} |
| 5 | {2, 4} |
| 6 | {3, 4} |

Table 2 indicates different timeslots to which different codebooks may correspond, that is, mapping of modulated symbols of different codebooks to corresponding timeslots means that the codebook may indicate the symbol-timeslot mapping relationship, that is, indicate the correspondence between the modulated symbols and the timeslots.

A block including bits b^{(q)}(0),K, b^{(q)}(M_{bit}^{(q)}−1) is modulated based on the codebook shown in Table 1, to obtain a block including complex-domain symbols

$$[ \begin{matrix}{d}_{1}^{( q )} ( 0 ) , K , {d}_{1}^{( q )} ( {M}_{symb}^{( q )} - 1 ) \\ {d}_{2}^{( q )} ( 0 ) , K , {d}_{2}^{( q )} ( {M}_{symb}^{( q )} - 1 )\end{matrix} ] .$$

d₁^{(q)}(n),n=0,K,M_{symb}^{(q)}−1 is a symbol mapped to a first allocated timeslot, and d₂^{(q)}(n),n=0,K,M_{symb}^{(q)}−1 is a symbol mapped to a second allocated timeslot. The complex-domain symbols

$$[ \begin{matrix}{d}_{1}^{( q )} ( 0 ) , K , {d}_{1}^{( q )} ( {M}_{symb}^{( q )} - 1 ) \\ {d}_{2}^{( q )} ( 0 ) , K , {d}_{2}^{( q )} ( {M}_{symb}^{( q )} - 1 )\end{matrix} ]$$

should be sequentially mapped, starting from d^{(q)}(0), to a physical resource block not used for pilot transmission in each timeslot. The two allocated timeslots correspond to available resource timeslots shown in Table 2. In Table 2, a is a timeslot index of the first allocated timeslot, and b is an index of the second allocated timeslot. For a specific mapping manner, refer to FIG. 4.

FIG. 4 shows a mapping location corresponding to each codebook in the 6×4 codebook set. A gray block in the figure represents a number of a timeslot (slot) in which a modulated symbol generated by means encoding by using the codebook is arranged in a single system frame. Using a codebook 1 as an example, the first gray block represents that S1(xx) needs to be arranged in the first timeslot in the system frame, and the second gray block represents that S2(xx) needs to be arranged in the third timeslot in the system frame. Using a codebook 2 as an example, the first gray block represents that S1(xx) needs to be arranged in the second timeslot in the system frame, and the second gray block represents that S2(xx) needs to be arranged in the third timeslot in the system frame. For timeslots corresponding to other codebooks, refer to the figure, and details are not described herein.

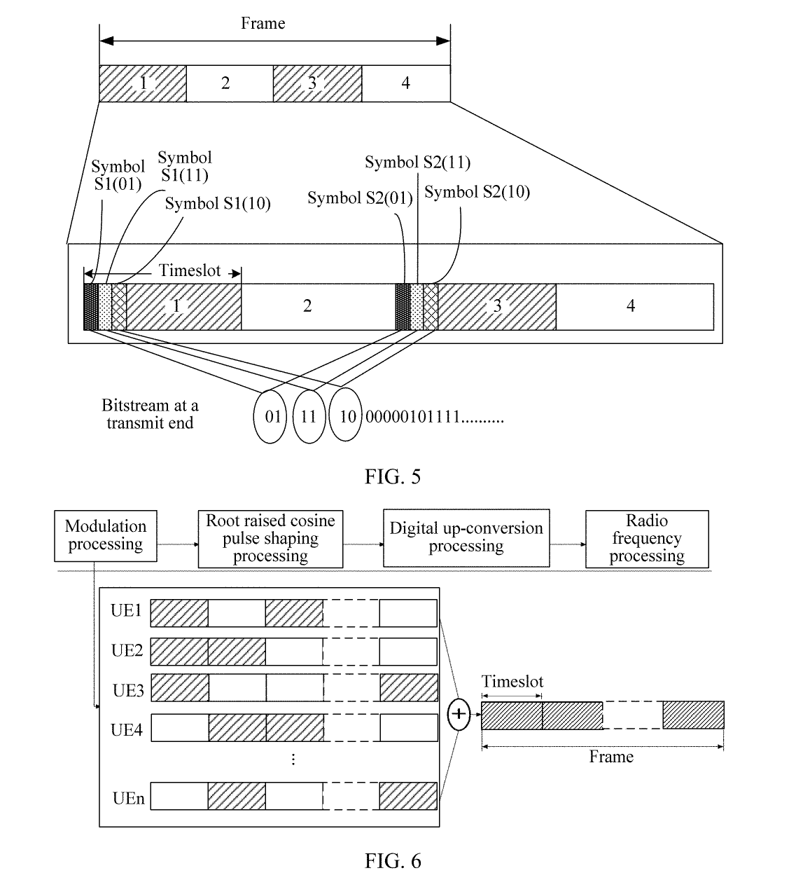

The following specifically describes, with reference to FIG. 5 and by using an example in which the terminal device selects the codebook 1 in FIG. 3, how the terminal device performs modulation processing on the to-be-sent bitstream.

The terminal device selects two continuous bits, for example, the first bit group “01” in FIG. 5, from a to-be-transmitted bitstream. After the selected two bits are mapped by using the selected codebook, a group of two modulated symbols S1(01) and S2(01) is generated. Based on a selection order for the bitstream, the terminal device arranges the generated S1(01) in the first symbol location in a timeslot 1 that is in a system frame and that is indicated by the selected codebook, and arranges S2(01) in the first symbol location in a timeslot 3 in the system frame. The terminal device continues to select two continuous bits, for example, the second bit group “11” in the figure. After the selected two bits are mapped by using the selected codebook, a group of two modulated symbols S1(11) and S2(11) is generated. The generated modulated symbols S1(11) and S2(11) are also arranged in the timeslot 1 and the timeslot 3 that are indicated by the selected codebook, and are sequentially arranged after S1(01) and S2(01) respectively. The terminal device continues to select two continuous bits, for example, the third bit group “10” in FIG. 4. After the selected two bits are mapped by using the selected codebook, a group of two modulated symbols S1(10) and S2(10) is generated. The generated modulated symbols S1(10) and S2(10) are also arranged in the timeslot 1 and the timeslot 3 that are indicated by the selected codebook, and are sequentially arranged after S1(11) and S2(11) respectively. A process of processing subsequent bits in the bitstream is the same as the data modulation and resource mapping processes described above.

After each of a plurality of terminal devices performs the processing process shown in FIG. 5, multiplexing of a time domain resource can be implemented. For example, as shown in FIG. 6, after selecting codebooks in a codebook set and performing modulation processing and resource mapping processing, a plurality of terminal devices UE1, UE2, UE3, UE4, . . . , and UEn may each transmit an output by using a same data frame. Root raised cosine pulse shaping processing, digital up-conversion processing, radio frequency processing, and the like may be performed after modulation.

In this embodiment of this application, the mapped modulated symbols may be sent by using the single carrier, that is, the mapped modulated symbols may be sent by using one carrier, rather than a plurality of carriers. Sending the mapped modulated symbols by using the single carrier enables the receive end to have advantages of a simple structure and wide coverage of a single-carrier system and enables a time domain signal of the transmit end to have an advantage of a low PAPR.

In this embodiment of this application, a subcarrier may be selected from a plurality of subcarriers as the single carrier. The plurality of subcarriers constitute a continuous spectrum. The plurality of single carriers may have a same carrier width, or there are at least two subcarriers having different carrier widths.

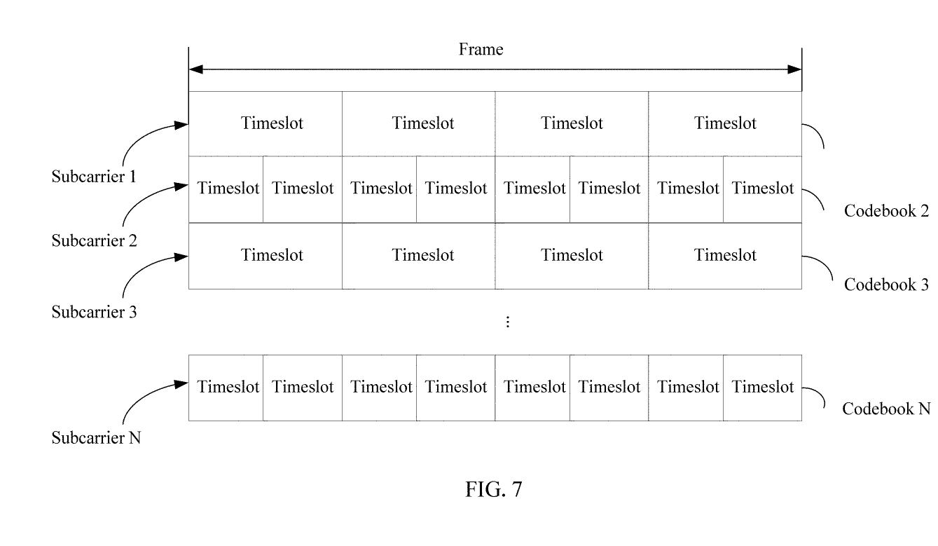

FIG. 7 is a diagram of resource allocation of timeslots having a same carrier width and subcarriers. Independent codebook sets, that is, a codebook set 1, a codebook set 2, a codebook set 3, and a codebook set N, are used on different subcarriers. The codebook sets may be the same or different. A single system frame is divided into different quantities of equal-length timeslots based on different specifications of codebook sets used on different subcarriers. In a single system frame, one terminal device may occupy only one subcarrier to send data, and select a codebook in a codebook set corresponding to the subcarrier to process the data by using the method shown in FIG. 1 and FIG. 2.

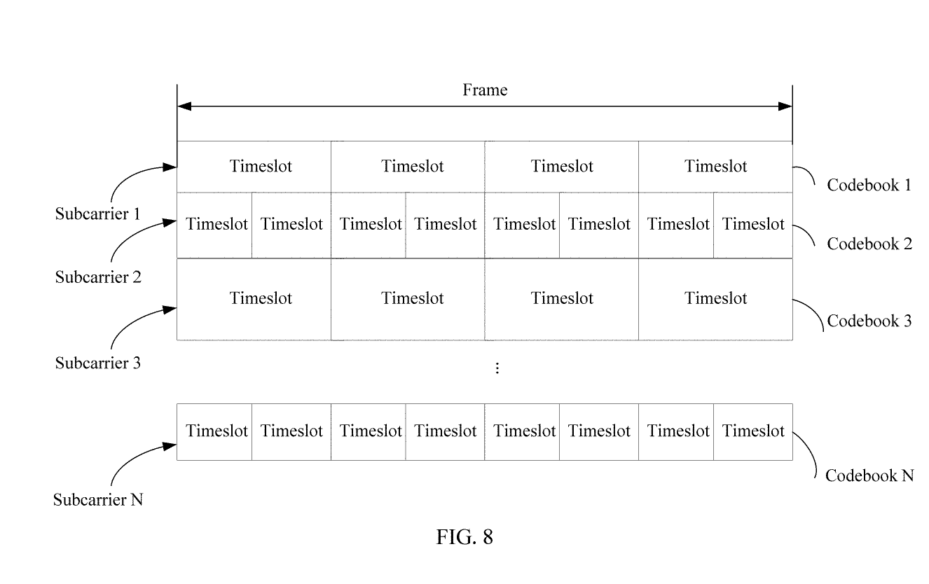

FIG. 8 is a diagram of resource allocation of timeslots having different carrier widths and subcarriers. Independent codebook sets, that is, a codebook set 1, a codebook set 2, a codebook set 3, and a codebook set N, are used on different subcarriers. The codebook sets may be the same or different. A single system frame is divided into different quantities of equal-length timeslots based on different specifications of codebook sets used on different subcarriers. In a single system frame, one terminal device occupies only one subcarrier to send data, and selects a codebook in a codebook set corresponding to the subcarrier to process the data by using the method shown in FIG. 1 and FIG. 2.

The terminal device may select the subcarrier based on a transmission rate required by the terminal device and/or a distance between the terminal device and the receive end. For example, as a distance between a terminal and a base station increases, a narrower carrier width is selected. This is because same energy, when distributed on a narrower spectrum, can be transmitted over a longer distance. As the distance between the terminal and the base station decreases, a transmission distance also decreases. In this case, the terminal may properly select a larger carrier width and distribute the energy on a wider frequency band to communicate with the base station at a higher rate.

Optionally, in this embodiment of this application, the communications device may determine a to-be-used codebook set based on a time domain resource to be used for data transmission. For example, in four timeslots, a 6×4 codebook set is used. In next four timeslot, another 6×4 codebook set is used. The communications device may alternatively determine the to-be-used codebook set based on the subcarrier and a time domain resource that are to be used for data transmission. For example, the selected subcarrier indicates that a specification of the to-be-used codebook set is 6×4, and a specific 6×4 codebook set to be used may be determined based on the time domain resource to be used.

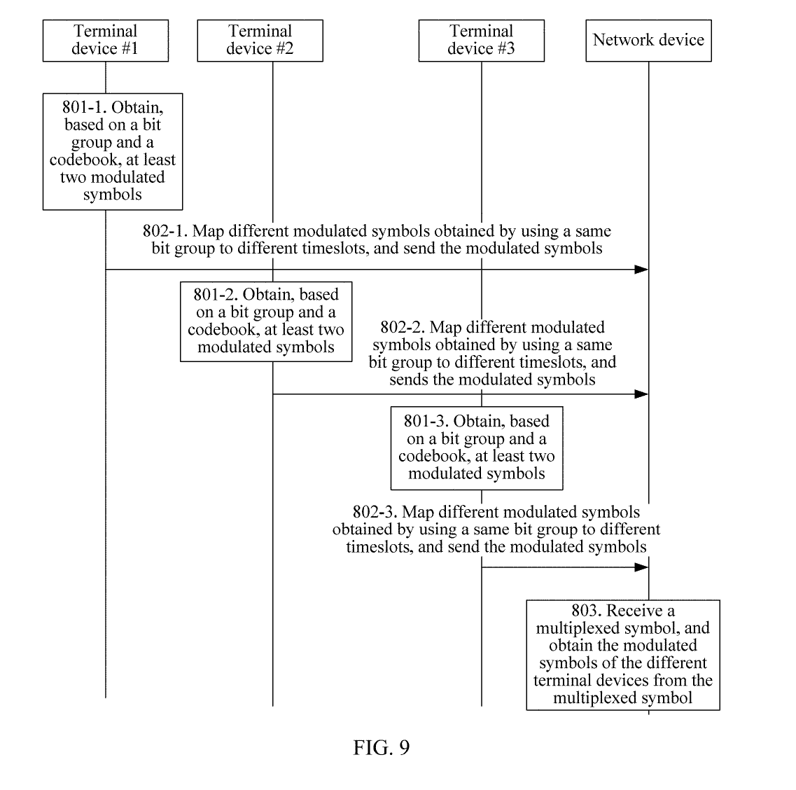

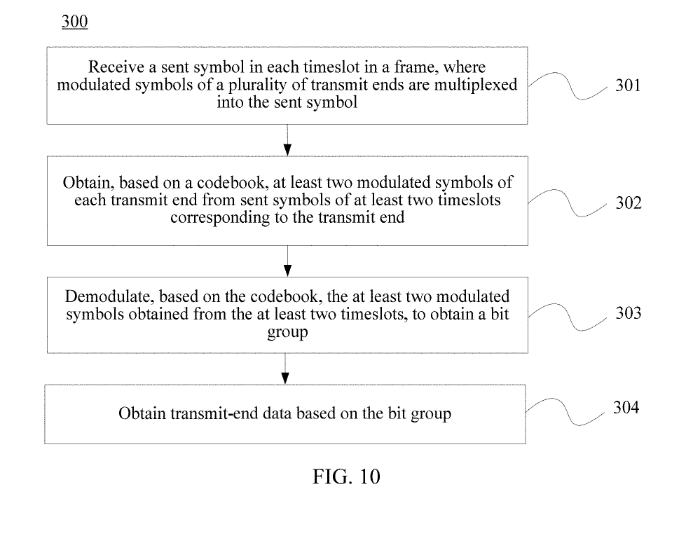

It should be understood that the foregoing describes how a terminal device obtains modulated symbols based on a codebook, maps the modulated symbols to a corresponding resource, and sends the modulated symbols to a network device. In an embodiment of this application, for example, as shown in FIG. 9, a plurality of terminal devices, that is, a terminal device #1, a terminal device #2, a terminal device #3, and a terminal device #4, may each select a codebook from a codebook set, obtain modulated symbols, map the modulated symbols to a corresponding resource, and send the modulated symbols to a network device. For specific operations performed by each terminal device, refer to the foregoing description. Specifically, in 801-1, the terminal device #1 obtains, based on a bit group and a codebook, at least two modulated symbols. In 802-1, the terminal device #1 maps different modulated symbols obtained by using a same bit group to different timeslots, and sends the modulated symbols to the netwok device. In 801-2, the terminal device #2 obtains, based on a bit group and a codebook, at least two modulated symbols. In 802-2, the terminal device #2 maps different modulated symbols obtained by using a same bit group to different timeslots, and sends the modulated symbols to the network device. In 801-3, the terminal device #3 obtains, based on a bit group and a codebook, at least two modulated symbols. In 802-3, the terminal device #3 maps different modulated symbols obtained by using a same bit group to different timeslots, and sends the modulated symbols to the network device. It should be understood that although the steps shown in the figure are vertically arranged, such an arrangement is merely for convenience of layout. Different terminal devices may use a same time domain resource to send modulated symbols. The modulated symbols sent by the plurality of terminal devices by using the same time domain resource constitute a multiplexed symbol. In 803, after receiving the multiplexed symbol, the network device may obtain the modulated symbols of each terminal device from the multiplexed symbol. For a specific obtaining manner, refer to a description about FIG. 10.

FIG. 10 is a schematic flowchart of a signal transmission method 300 according to an embodiment of this application. The method may be applied to a 5G communications system, and specifically, may be applied to an M2M communication service that includes, but is not limited to, intelligent meter reading, smart grid, security monitoring, forest protection, intelligent transportation, electronic medical treatment, and the like in a large-scale MTC communication scenario in the 5G communications system. The method may be performed by a communications device, for example, a network device, which is specifically a base station. A description is provided below mainly by using a network device as an example, but this application is not limited thereto.

In 301, the communications device receives a multiplexed symbol in each timeslot in a frame, where modulated symbols of a plurality of transmit ends are multiplexed into the multiplexed symbol.

The device obtains, based on a codebook, at least two modulated symbols of each transmit end from multiplexed symbols of at least two timeslots corresponding to the transmit end.

In 303, the communications device demodulates, based on the codebook, the at least two modulated symbols obtained from the at least two timeslots, to obtain a bit group.

In 304, the communications device obtains transmit-end data based on the bit group.

Specifically, the network device may detect a pilot corresponding to data sent in a current subframe, and then determine, based on a correspondence between the pilot and codebooks, all codebooks that may be used. Then, the network device may extract, based on a symbol-timeslot mapping relationship, a received symbol from a corresponding location in each of the at least two timeslots mapped in the codebook to constitute a data block. Each data block is a received signal obtained after channel superposition is performed on SCMA modulation code words of a plurality of users at a transmit end. A receiver uses such a data block as a basic decoding unit. Then, SCMA decoding may be performed on the modulated symbols based on a bit-symbol mapping relationship in the codebook, to obtain a corresponding bit group.

A decoding algorithm referred to as a message passing algorithm (Message Passing Algorithm, MPA) is used in SCMA decoding. A decoding manner of the MPA may be considered as a message passing process. The term “message” herein is a guess for a modulated symbol used by an SCMA encoder at the transmit end. A relationship between each user and a timeslot resource used by the SCMA decoding basic unit is established by using SCMA modulated symbols, and a “guess” for each modulated symbol is iteratively passed between the user and the timeslot resource. In an iteration process, reliability of the “guesses” changes until a maximum quantity of iterations of a system is reached. In the iteration process, the message passing algorithm improves the reliability of the “guesses”, thereby implementing reliable encoding.

In this embodiment of this application, each timeslot in the frame includes a plurality of continuous modulated symbol receiving locations. The base station sequentially obtains modulated symbols in each timeslot, and each time modulated symbols obtained in corresponding locations in at least two timeslots are used for co-demodulation to obtain a bit group.

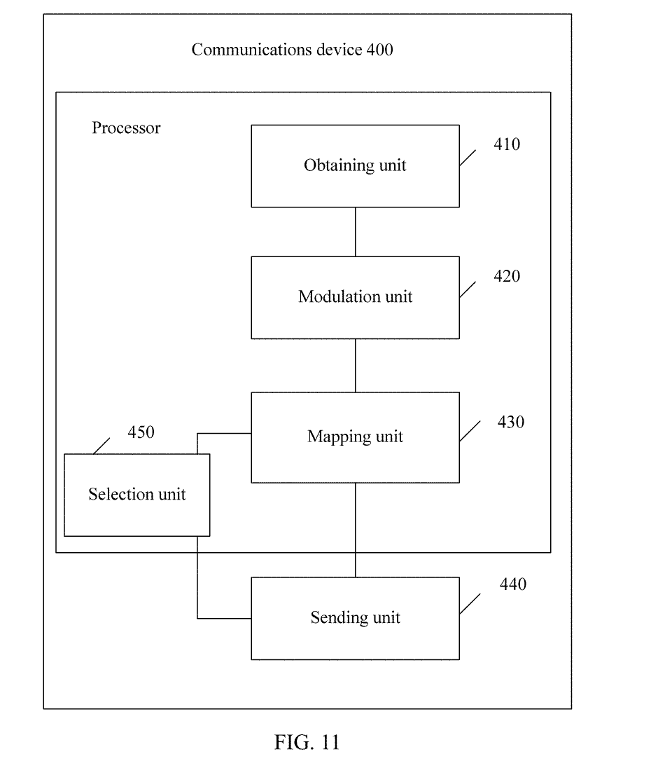

The foregoing has described the signal transmission method according to the embodiments of this application with reference to FIG. 1 to FIG. 10, and the following describes a signal transmission apparatus according to the embodiments of this application with reference to FIG. 11 to FIG. 14.

FIG. 11 is a schematic block diagram of a communications device 400 according to an embodiment of this application. As shown in FIG. 11, the communications device 400 includes an obtaining unit 410, a modulation unit 420, a mapping unit 430, and a sending unit 440.

Specifically, the obtaining unit 410 is configured to obtain a bit group from a to-be-sent bitstream. Optionally, the bit group includes at least two bits. The modulation unit 420 is configured to modulate, by the communications device, the bit group based on a codebook to obtain at least two modulated symbols. The mapping unit 430 is configured to map each of the at least two modulated symbols to a corresponding timeslot in a frame. The sending unit 440 is configured to send the mapped at least two modulated symbols. Different modulated symbols obtained by using a same bit group are mapped to different timeslots, and each timeslot includes a plurality of continuous modulated symbol mapping locations used to map modulated symbols obtained by using a plurality of bit groups of the to-be-sent bitstream.

Optionally, the codebook indicates a correspondence between bit groups and modulated symbols and a correspondence between modulated symbols and timeslots.

Optionally, a ranking of each modulated symbol in the plurality of continuous modulated symbol mapping locations is consistent with a ranking of a corresponding bit group in the to-be-sent bitstream.

Optionally, a quantity of timeslots in the frame is the same as a quantity of timeslots corresponding to a codebook set to which the codebook belongs. Optionally, lengths of the timeslots in the frame are equal. Alternatively, the lengths of the timeslots in the frame may not be equal.

Optionally, the sending unit 430 is specifically configured to send the mapped at least two modulated symbols by using a single carrier.

Optionally, as shown in FIG. 11, the apparatus 400 further includes: a selection unit 450, configured to select a subcarrier from a plurality of subcarriers as the single carrier, to send the mapped at least two modulated symbols. The plurality of subcarriers constitute a continuous spectrum. The codebook used may be determined in a codebook set corresponding to the selected subcarrier.

Optionally, the apparatus 400 is a terminal device.

Optionally, as shown in FIG. 11, the obtaining unit 410, the modulation unit 420, and the mapping unit 430 belong to a processor, that is, the units are implemented by the processor. Optionally, as shown in FIG. 11, the optional selection unit 450 also belongs to the processor.

It should be understood that the communications device 400 according to this embodiment of this application may correspond to the communications device performing the method 200 in the embodiments of this application, and the foregoing operations and/or functions of the units in the communications device 400 may be used to perform the procedures and/or steps corresponding to the terminal device in the foregoing method embodiment. To avoid repetition, details are not described herein again.

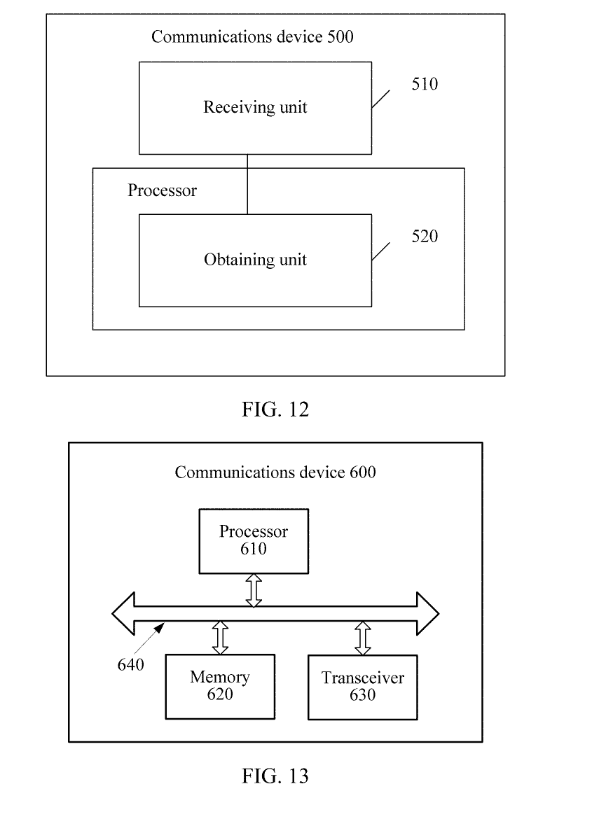

FIG. 12 is a schematic block diagram of a signal transmission apparatus 500 according to an embodiment of this application. As shown in FIG. 12, the apparatus 500 includes a receiving unit 510 and an obtaining unit 520.

Specifically, the receiving unit 510 is configured to receive a multiplexed symbol in each timeslot in a frame, where modulated symbols of a plurality of transmit ends are multiplexed into the multiplexed symbol. The obtaining unit 520 is configured to: obtain, based on a codebook, at least two modulated symbols of each transmit end from multiplexed symbols of at least two timeslots corresponding to the transmit end; demodulate, based on the codebook, the at least two modulated symbols obtained from the at least two timeslots, to obtain a bit group; and obtain transmit-end data based on the bit group.

Optionally, a quantity of timeslots in the frame is the same as a quantity of timeslots corresponding to a codebook set to which the codebook belongs. Optionally, lengths of the timeslots in the frame are equal. Alternatively, the lengths of the timeslots in the frame may not be equal.

Optionally, the codebook indicates a correspondence between bit groups and modulated symbols and a correspondence between modulated symbols and timeslots.

Optionally, each timeslot includes a plurality of continuous symbol mapping locations, and the second obtaining unit 520 is specifically configured to:

sequentially obtain received symbols in the plurality of continuous symbol mapping locations in each timeslot, where each time received symbols obtained in corresponding locations in at least two timeslots are used for co-demodulation to obtain a bit group.

Optionally, the communications device 500 is a network device, for example, a base station.

Optionally, the obtaining unit 510 may belong to a processor, that is, the unit is implemented by the processor.

It should be understood that the communications device 500 according to this embodiment of this application may correspond to the communications device performing the method 300 in the embodiments of this application, and the foregoing operations and/or functions of the units in the communications device 500 may be used to perform the procedures and/or steps corresponding to the terminal device in the foregoing method embodiment. To avoid repetition, details are not described herein again.

FIG. 13 is a schematic block diagram of a signal transmission apparatus 600 according to an embodiment of this application. The apparatus 600 includes a processor 610, a memory 620, and a transceiver 630. The memory 620 is configured to store a program instruction. The processor 610 may invoke the program instruction stored in the memory 620, and may perform one or more steps in the embodiment shown in FIG. 2 or the optional implementations of the embodiment.

Specifically, the processor 610 obtains a bit group from a to-be-sent bitstream, where the bit group includes at least two bits. The communications device modulates the bit group based on a codebook to obtain at least two modulated symbols; maps each of the at least two modulated symbols to a corresponding timeslot in a frame; and sends the mapped at least two modulated symbols by using the transceiver 630. Different modulated symbols obtained by using a same bit group are mapped to different timeslots, and each timeslot includes a plurality of continuous modulated symbol mapping locations used to map modulated symbols obtained by using a plurality of bit groups of the to-be-sent bitstream.

Optionally, the processor 610 sends the mapped at least two modulated symbols on a single carrier by using the transceiver 630.

Optionally, the processor 610 selects a subcarrier from a plurality of subcarriers as the single carrier, to send the mapped at least two modulated symbols, where the plurality of subcarriers constitute a continuous spectrum. The codebook may be determined in a codebook set corresponding to the selected subcarrier.

Optionally, as shown in FIG. 13, the communications device 600 may further include a bus system 640. The processor 610, the memory 620, and the transceiver 630 are connected by using the bus system 640. The communications device 600 may be optionally a terminal device.

The memory may include a volatile memory (volatile memory), for example, a random access memory (random-access memory, RAM). The memory may also include a non-volatile memory (non-volatile memory), for example, a flash memory (flash memory), a hard disk drive (hard disk drive, HDD), or a solid-state drive (solid-state drive, SSD). The memory may further include a combination of the foregoing types of memories.

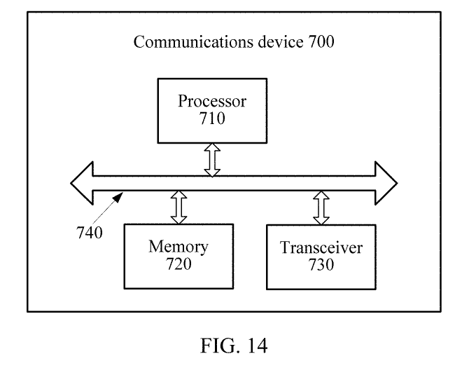

FIG. 14 is a schematic block diagram of a signal transmission apparatus 600 according to an embodiment of this application. The apparatus 700 includes a processor 710, a memory 720, and a transceiver 730. The memory 720 is configured to store a program instruction. The processor 710 may invoke the program instruction stored in the memory 720, and may perform one or more steps in the embodiment shown in FIG. 9 or the optional implementations of the embodiment.

The apparatus 700 may be optionally a network device, for example, a base station.

Specifically, the processor 710 receives a multiplexed symbol in each timeslot in a frame by using the transceiver 730, where modulated symbols of a plurality of transmit ends are multiplexed into the multiplexed symbol; obtains, based on a codebook, at least two modulated symbols of each transmit end from multiplexed symbols of at least two timeslots corresponding to the transmit end; demodulates, based on the codebook, the at least two modulated symbols obtained from the at least two timeslots, to obtain a bit group; and obtains transmit-end data based on the bit group.

Optionally, as shown in FIG. 14, the communications device 700 may further include a bus system 740. The processor 710, the memory 720, and the transceiver 730 are connected by using the bus system 740. The processor 710, the memory 720, and the transceiver 730 may alternatively be connected in another manner, for example, may be directly connected. The communications device 700 may be optionally a terminal device.

In the embodiments of this application, the processor 610 or 710 may be a central processing unit (central processing unit, CPU), a network processor (network processor, NP), or a combination of a CPU and an NP. The processor 610 may further include a hardware chip. The hardware chip may be an application-specific integrated circuit (application-specific integrated circuit, ASIC), a programmable logic device (programmable logic device, PLD), or a combination thereof. The PLD may be a complex programmable logic device (complex programmable logic device, CPLD for short), a field-programmable gate array (field-programmable gate array, FPGA), a generic array logic (generic array logic, GAL), or any combination thereof.

In addition to a data bus, the bus system 640 or 740 may further include a power bus, a control bus, a status signal bus, and the like. For ease of illustration, only one bold line is used in the figures to represent the bus system 640 or 740, but it does not indicate that there is only one bus or one type of bus.

A person of ordinary skill in the art may be aware that, in combination with the examples described in the embodiments disclosed in this specification, units and algorithm steps may be implemented by electronic hardware or a combination of computer software and electronic hardware. A person skilled in the art may further be aware that, in combination with the examples described in the embodiments disclosed in this specification, units and algorithm steps may be implemented by electronic hardware, computer software, or a combination thereof. To clearly describe the interchangeability between the hardware and the software, the foregoing has generally described compositions and steps of each example based on functions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments, and details are not described herein again.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of the embodiments.

In addition, functional units in the embodiments of this application may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of this application essentially, or the part contributing to the prior art, or some of the technical solutions may be implemented in a form of a software product. The software product is stored in a storage medium, and includes several instructions for instructing a computer device (which may be a personal computer, a server, or a network device) to perform all or some of the steps of the methods described in the embodiments of this application. The foregoing storage medium includes: any medium that can store program code, such as a USB flash memory drive, a removable hard disk, a read-only memory (ROM, Read-Only Memory), a random access memory (RAM, Random Access Memory), a magnetic disk, or an optical disc.

The foregoing descriptions are merely specific implementation manners of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A signal transmission method, comprising:
obtaining, by a communications device, a bit group from a to-be-sent bitstream;
modulating, by the communications device, the bit group based on a codebook to obtain at least two modulated symbols;
mapping, by the communications device, each of the at least two modulated symbols to a corresponding timeslot in a frame; and
sending, by the communications device, the mapped at least two modulated symbols, wherein
different modulated symbols obtained by using a same bit group are mapped to different timeslots, and each timeslot comprises a plurality of continuous modulated symbol mapping locations used to map modulated symbols obtained by using a plurality of bit groups of the to-be-sent bitstream.

2. The method according to claim 1, wherein the codebook indicates a correspondence between bit groups and modulated symbols and a correspondence between modulated symbols and timeslots.

3. The method according to claim 1, wherein a quantity of timeslots comprised in the frame is a quantity of timeslots corresponding to a codebook set to which the codebook belongs.

4. The method according to claim 1, wherein the sending, by the communications device, the mapped at least two modulated symbols comprises:
sending, by the communications device, the mapped at least two modulated symbols by using a single carrier.

5. The method according to claim 4, wherein before the modulating, by the communications device, the bit group to obtain at least two modulated symbols, the method further comprises:
selecting a subcarrier from a plurality of subcarriers as the single carrier, to send the mapped at least two modulated symbols, wherein the plurality of subcarriers constitute a continuous spectrum; and
determining the codebook in a codebook set corresponding to the single carrier.

6. The method according to claim 1, wherein a ranking of each modulated symbol in the plurality of continuous modulated symbol mapping locations is consistent with a ranking of a corresponding bit group in the to-be-sent bitstream.

7. The method according to claim 1, wherein the codebook comprises a plurality of code words, each code word in the plurality of code words is a multidimensional complex vector, and each code word comprises at least one zero symbol and at least one non-zero symbol.

8. A communications device, comprising a processor, a memory, and a transceiver, wherein the memory is configured to store instructions that, when executed by the processor perform the following processing:
obtaining a bit group from a to-be-sent bitstream;
modulating, by the communications device, the bit group based on a codebook to obtain at least two modulated symbols;
mapping each of the at least two modulated symbols to a corresponding timeslot in a frame; and
instructing the transceiver to send the mapped at least two modulated symbols, wherein
different modulated symbols obtained by using a same bit group are mapped to different timeslots, and each timeslot comprises a plurality of continuous modulated symbol mapping locations used to map modulated symbols obtained by using a plurality of bit groups of the to-be-sent bitstream.

9. The communications device according to claim 8, wherein the codebook indicates a correspondence between bit groups and modulated symbols and a correspondence between modulated symbols and timeslots.

10. The communications device according to claim 8, wherein a quantity of timeslots comprised in the frame is a quantity of timeslots corresponding to a codebook set to which the codebook belongs.

11. The communications device according to claim 8, wherein the processor is configured to execute one or more instructions to perform the following processing:
instructing the transceiver to send the mapped at least two modulated symbols by using a single carrier.

12. The communications device according to claim 11, wherein the processor is configured to execute one or more instructions to perform the following processing:
selecting a subcarrier from a plurality of subcarriers as the single carrier, to send the mapped at least two modulated symbols, wherein the plurality of subcarriers constitute a continuous spectrum; and
determining the codebook in a codebook set corresponding to the single carrier.

13. The communications device according to claim 8, wherein a ranking of each modulated symbol in the plurality of continuous modulated symbol mapping locations is consistent with a ranking of a corresponding bit group in the to-be-sent bitstream.

14. The communications device according to claim 8, wherein the codebook comprises a plurality of code words, each code word in the plurality of code words is a multidimensional complex vector, and each code word comprises at least one zero symbol and at least one non-zero symbol.

15. A communications device, comprising a processor, a memory, and a transceiver, wherein the memory is configured to store instructions that, when executed by the processor perform the following processing:
instructing the transceiver to receive a multiplexed symbol in each timeslot in a frame, wherein modulated symbols of a plurality of transmit ends are multiplexed into the multiplexed symbol;
obtaining, based on a codebook, at least two modulated symbols of each transmit end from multiplexed symbols of at least two timeslots corresponding to the transmit end;
demodulating, based on the codebook, the at least two modulated symbols obtained from the at least two timeslots, to obtain a bit group; and
obtaining transmit-end data based on the bit group.

16. The communications device according to claim 15, wherein the codebook indicates a correspondence between bit groups and modulated symbols and a correspondence between modulated symbols and timeslots.

17. The communications device according to claim 15, wherein a quantity of timeslots comprised in the frame is a quantity of timeslots corresponding to a codebook set to which the codebook belongs.

18. The communications device according to claim 15, wherein each timeslot comprises a plurality of continuous symbol mapping locations, and the processor is configured to execute one or more instructions to perform the following processing:
sequentially obtaining modulated symbols in the plurality of continuous symbol mapping locations in each timeslot, wherein each time modulated symbols obtained in corresponding locations in at least two timeslots are used for co-demodulation to obtain a bit group.

19. The communications device according to claim 15, wherein the codebook comprises a plurality of code words, the code word is a multidimensional complex vector, and the code word comprises at least one zero symbol and at least one non-zero symbol.
